(19) United States
(12) Patent Application Publication
(10) Pub. No.: US 2006/0117308 A1
(43) Pub. Date: Jun. 1, 2006

(54) Data processing apparatus and ic card

(75) Inventors: Kazuya Hirayanagi, Komae (JP); Kenji Kitagawa, Yokohama (JP); Kesami Hagiwara, Koganei (JP); Tkanori Aoki, Kodaira (JP); Naoki Mitsuishi, Kodaira (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 10/521,551

(22) PCT Filed: Aug. 30, 2002
(86) PCT No.: PCT/JP02/08843

§ 371 Date: Nov. 9, 2005

(51) Int. Cl. G06F 9/45

(52) U.S. Cl. 717/148

(57) ABSTRACT

A data processing apparatus (1) can implement the execution of a virtual machine instruction based on an execution routine specified by the native instruction of a CPU (2) and has an address converting unit (3) capable of sequentially converting an address output from the CPU into the address of the native instruction by utilizing the address of a prepared execution routine in response to the application of a prescribed condition. The address converting unit reads a virtual machine instruction to be executed next and prepares the address of an execution routine corresponding thereto in parallel with the execution of the execution routine by the CPU based on the address of the native instruction which is sequentially converted. Accordingly, it is possible to reduce the overhead of a processing of loading the virtual machine instruction and a processing of executing an instruction in accordance with the execution routine which is caused by an address calculation processing based on the load processing. Consequently, it is possible to increase the speed of a data processing to be carried out by a virtual machine program described in a virtual machine instruction.

### FIELD OF THE INVENTION

The present invention relates to a data processing apparatus capable of executing a virtual machine instruction by using the native instruction of a CPU, and an effective technique which is applied to a microcomputer for an IC card, for example.

### BACKGROUND OF THE INVENTION

A technique capable of executing a virtual machine instruction by using the native instruction of a CPU, that is, a technique for executing a virtual machine instruction over a CPU having an inherent instruction set includes an implementing technique using an interpreter software. The executing method using the interpreter software loads a virtual instruction onto a CPU, recognizes the virtual instruction thus loaded and calls the function of an execution routine corresponding thereto, thereby executing the execution routine to implement a processing specified by the virtual instruction. In the execution routine, the operation of the corresponding virtual machine instruction is described in an instruction (the native instruction of the CPU) included in an instruction set which is peculiar to the CPU. When the processing of one execution routine is ended, a jump to a processing of loading the virtual machine instruction is carried out. By repeating this operation, a virtual machine program described in the virtual machine instruction can be executed by using the native instruction of the CPU. In this technique, the processing of loading the virtual machine instruction, deciding the virtual machine instruction thus loaded and calling the function of the execution routine corresponding to the virtual machine thus decided causes an overhead.

JP-P2001-508907A and JP-P2001-508908A have described a technique for reducing the overhead of the execution routine call. More specifically, there is employed a hardware for loading a virtual machine instruction by using a program counter for loading the virtual machine instruction and calculating an execution routine address from the virtual machine instruction thus loaded when the instruction fetching address of the CPU is output by utilizing a part of the instruction fetching address of the CPU for the program counter.

### SUMMARY OF THE INVENTION

It was proved by the inventor that a processing of loading a virtual machine instruction and a processing of calculating an execution routine address are carried out in series to an instruction execution processing in accordance with an execution routine by using the hardware described in the Patent Documents so that the load processing and the address calculation processing still cause an overhead for the instruction execution processing in accordance with the execution routine.

It is an object of the invention to reduce the overhead of an instruction execution processing in accordance with an execution routine which is caused by a processing of loading a virtual machine instruction and an address calculation processing based thereon.

It is another object of the invention to increase the speed of a data processing based on a virtual machine program described in a virtual machine instruction.

The above and other objects and novel features of the invention will be apparent from the following description and the accompanying drawings.

A data processing apparatus according to the invention can implement an execution of a virtual machine instruction based on an execution routine specified by a native instruction of a CPU and has an address converting unit capable of sequentially converting an address output from the CPU into an address of the native instruction by utilizing an address of a prepared execution routine in response to an application of a prescribed condition. The address converting unit reads a virtual machine instruction to be executed next and prepares an address of an execution routine corresponding thereto in parallel with an execution of the execution routine by the CPU based on the address of the native instruction which is sequentially converted. In brief, the data processing apparatus according to the invention carries out the processing of loading the next virtual machine instruction and the processing of preparing the address of the execution routine corresponding to the virtual machine instruction thus loaded in parallel with the processing of executing the execution routine based on the CPU instruction set corresponding to the virtual machine instruction. Accordingly, it is possible to reduce the overhead of the instruction execution processing in accordance with the execution routine which is caused by the processing of loading the virtual machine instruction and the address calculation processing based thereon. Consequently, it is possible to increase the speed of the data processing based on the virtual machine program described in the virtual machine instruction.

The address converting unit exactly outputs an address input from the CPU in response to a non-application of the prescribed condition. More specifically, when the prescribed condition is not applied, the CPU fetches and executes the instruction from the program described in the native instruction other than the execution routine.

The prescribed condition is an output of a predetermined address by the CPU, for example. The predetermined address is a starting address of a predetermined address space assigned to the execution of the virtual machine instruction, for example. At this time, for example, the execution routine includes a native instruction of a return processing of returning a program counter of the CPU to a head of the predetermined address space assigned to the execution of the virtual machine instruction at an end thereof. When the return to the head of the predetermined address space is carried out at the end of the execution routine, the address of the execution routine corresponding to the virtual machine instruction to be executed next has already been prepared, and the CPU carries out the processing of giving access to the starting address of the predetermined address space again. Consequently, it is possible to carry out a transition to the execution of the execution routine of the prepared address.

For a desirable mode, the apparatus has a conversion table for defining a correspondence of an instruction length to an address of an execution routine for the virtual machine instruction. The address converting unit acquires the instruction length of the corresponding virtual machine instruction and the address of the execution routine from the conversion table by setting the read virtual machine instruction as a retrieval key. The instruction length is utilized for generating the address of a virtual machine instruction to be read next. This is carried out in order to cope with the case in which the instruction word length of the virtual machine instruction is different for each instruction. The address of the execution routine which is retrieved is set to be an address on a high order side for specifying the storage area of the execution routine, and is utilized for generating an address to fetch the native instruction of a next execution routine. In the case in which they are utilized, it is desirable to have a first register for holding the retrieved instruction length and a second register for holding the address of the retrieved execution routine. For example, the address converting unit has a virtual machine program counter for outputting an address to read a virtual machine instruction from a memory and an amount of an increment of the virtual machine program counter can be controlled based on a value of the first register. It is sufficient that the increment of the virtual machine program counter is carried out synchronously with an execution end timing of a current execution routine. Moreover, it is preferable that the address converting unit should have an execution routine address generating circuit for reading a native instruction of an execution routine from a memory, and the execution routine address generating circuit should have a third register for inputting an address of an execution routine held by the second register and an adder for adding a value of the third register to a plurality of bits on a low order side of an address output from the CPU, and an output of the adder should be set and utilized to be an address of a native instruction of an execution routine.

When a virtual machine instruction which is read is a branch instruction, the address converting unit can read a virtual machine instruction of a branch destination and can prepare an address of an execution routine corresponding thereto. In case of the branch of the condition when the read virtual machine instruction is a conditional branch instruction, it is preferable that the address converting unit should read a virtual machine instruction of a branch destination and should separately prepare an address of an execution routine corresponding thereto, and should select an address of an execution routine to be utilized for an address calculation depending on a presence of a branch. A transition to a next execution routine can be carried out instantly irrespective of the application of the condition.

The data processing apparatus may comprise a first memory for storing a virtual machine program constituted by a virtual machine instruction and a second memory for storing an execution routine thereof for each virtual machine instruction and may be formed on a semiconductor chip. Moreover, the first memory and the second memory may be a separate chip from the CPU and the address converting unit.

It is desirable that the first memory should be a rewritable non-volatile memory. The main reason why the virtual machine instruction is used is the portability of a program to a data processing apparatus (platform) having a different architecture. A program expressed in the virtual machine instruction can easily be executed over plural kinds of data processing apparatuses by substituting the virtual machine instruction with the execution routine based on the instruction set which is peculiar to the data processing apparatus. Such an execution routine can easily be made constant irrespective of a virtual machine program over the data processing apparatus having the same architecture. If the first memory for storing the virtual machine program is set to be rewritable, therefore, the second memory does not need to be rewritable.

The data processing apparatus can be applied to an IC card mounted on a card board together with an input/output circuit. The input/output circuit to be employed may have a contact interface form or a non-contact interface form using a radio wave. In the case in which the virtual machine program is encrypted and supplied from an outside, and is decoded on an inside and is stored in a memory in the IC card, it is desirable that the first memory should be a rewritable non-volatile memory.

### BRIEF DESCRIPTION OF THE DRAWINGS

FIG. 1 is a block diagram showing an example of a microcomputer to which the invention is applied,

FIG. 2 is a block diagram illustrating the details of a VIPC unit,

FIG. 3 is a block diagram illustrating the details of an execution address generating unit,

FIG. 4 is an explanatory diagram illustrating the processing program of a CPU for carrying out a transition from an initial state to the execution state of a virtual machine instruction,

FIG. 5 is an explanatory diagram illustrating an execution routine other than a branch instruction,

FIG. 6 is an explanatory diagram illustrating an execution routine corresponding to a variable-length instruction,

FIG. 7 is an explanatory diagram wholly showing the address converting function of an address converting unit,

FIG. 8 is an explanatory diagram typically showing the function of executing a virtual machine instruction using the address converting function of the address converting unit,

FIG. 9 is an explanatory diagram showing the image of an address conversion using the address converting unit,

FIG. 10 is an explanatory diagram typically showing the function of executing a virtual machine instruction according to a comparative example in which an execution routine is caused to have the function of loading a virtual machine instruction,

FIG. 11 is a block diagram illustrating a VIPC unit and a DISP unit for implementing an increase in the speed of a processing based on a conditional branch instruction of the virtual machine instruction,

FIG. 12 is a block diagram illustrating a VPC unit for implementing an increase in the speed of a processing based on a virtual machine conditional branch instruction,

FIG. 13 is an explanatory diagram illustrating an execution routine in the case in which the virtual machine instruction is the conditional branch instruction,

FIG. 14 is a block diagram wholly showing a microcomputer employing a method of increasing the speed of a processing of branching the virtual machine conditional branch instruction,

FIG. 15 is a timing chart illustrating the state of an operation for continuously executing a virtual machine instruction by the microcomputer in FIG. 1 or FIG. 14,

FIG. 16 is a block diagram showing the connecting configuration of a CPU, an address converting unit and a conversion table which is the basis of the timing in FIG. 15,

FIG. 17 is a block diagram schematically showing the whole microcomputer,

FIG. 18 is an address map for the microcomputer in FIG. 17,

FIG. 19 is a view showing the appearance of a contact interface type IC card to which the microcomputer is applied,

FIG. 20 is a view showing the appearance of a non-contact interface type IC card to which the microcomputer is applied, and

FIG. 21 is an explanatory diagram illustrating a method of generating an execution routine instruction address from an execution routine address and an address offset of a CPU.

### DETAILED DESCRIPTION OF THE PREFERRED EMBODIMENTS

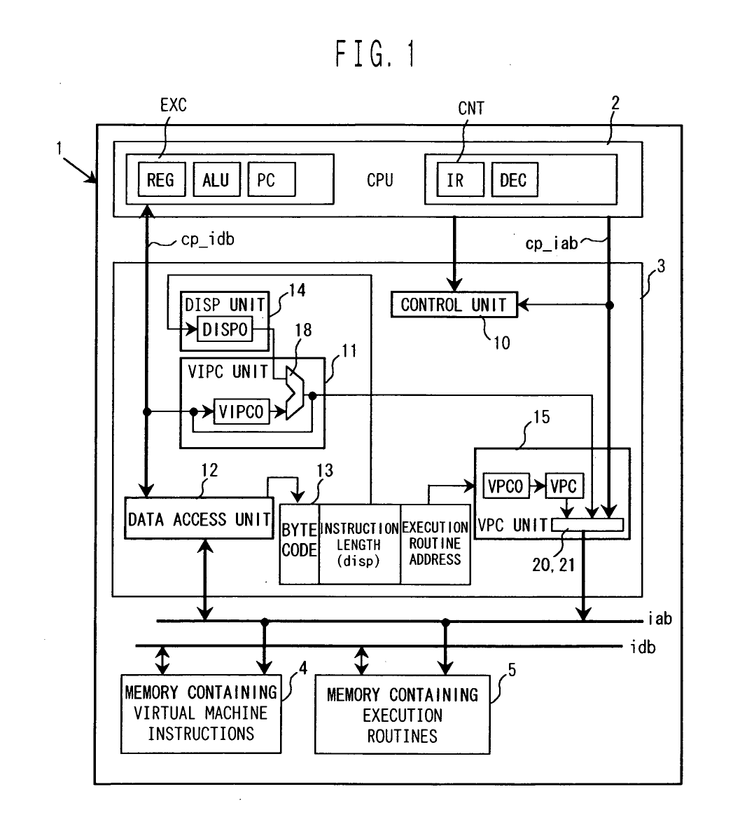

FIG. 1 shows an example of a microcomputer to which the invention is applied. A microcomputer 1 is constituted by a CPU (central processing unit) 2, an address converting unit (VEM) 3, a memory 4 containing virtual machine instructions, a memory 5 containing execution routines, an address bus iab, and a data bus idb which are typically shown in FIG. 1.

The CPU 2 has a predetermined instruction set, and the instruction set includes a plurality of prescribed native instructions. The CPU 2 has an instruction control unit CNT and an executing unit EXC. The instruction control unit CNT controls the order of execution of an instruction, and furthermore, fetches an instruction to an instruction register IR from an instruction address specified by a program counter PC and decodes the fetched instruction by means of a decoder DEC to generate a control signal. The executing unit EXC has the program counter PC, a general purpose register REG and an arithmetic logic unit ALU, and operates the general purpose register REG and the arithmetic logic unit ALU based on the control signal generated by the instruction control unit CNT, thereby executing an instruction.

The microcomputer 1 can implement the execution of a virtual machine instruction in accordance with an execution routine prescribed in the native instruction of the CPU 2. The virtual machine instruction is an instruction constituting a language in an application execution form over an IC card operating system referred to as an MULTOS®, for example. A virtual machine program based on the virtual machine instruction is held in the memory 4 containing virtual machine instructions. The execution routine is held in the memory 5 containing execution routines. A part of the address space of the CPU 2 is assigned to the execution of the virtual machine instruction, which is not particularly restricted. The space will be referred to as a virtual machine instruction execution space. The address converting unit 3 decides that a prescribed condition is applied when an instruction address output from the CPU 2 indicates a predetermined address of the virtual machine instruction execution space, for example, a starting address thereof.

The address converting unit 3 has a control unit 10 for deciding whether or not the prescribed condition is applied and controlling the whole address converting unit 3, and an execution address generating unit (an example of an execution routine address generating unit) 15. The execution address generating unit (VPC unit) 15 sequentially converts an instruction address output to a bus cp_iab by the CPU 2 into the address of a native instruction by utilizing the address of an execution routine prepared for an execution routine starting address register VPC in response to the fact that the prescribed condition is applied, and outputs the same address to the bus iab. When the prescribed condition is not applied, the execution address generating unit 15 exactly outputs the instruction address sent to the bus cp_iab by the CPU 2 to the bus iab. The CPU 2 inputs the native instruction read from the memory 5 containing execution routines based on the address of the native instruction converted sequentially through data buses idb and cp_idb, and executes the native instruction. The address converting unit 3 reads a virtual machine instruction to be executed next from the memory 4 containing virtual machine instructions in parallel with the execution of the execution routine of the virtual machine instruction in response to the fact that the prescribed condition is applied, and prepares the address of an execution routine corresponding thereto for a register VPC0 (an example of a second register). A virtual machine program counter unit (VIPC unit) 11 generates an address for giving access to the memory 4 containing virtual machine instructions and outputs the same address to the address bus iab via the VPC unit 15.

The amount of an address increment in the virtual machine program counter unit 11 is determined by the set value of a register DISP0 (an example of a first register) of an increment control unit (DISP unit) 14.

A data access unit 12 inputs the virtual machine instruction read from the memory 4 containing virtual machine instructions onto the bus idb. The address converting unit 3 has a conversion table 13 which defines the correspondence of an instruction code (byte code), an instruction length (disp) and an execution routine address every virtual machine instruction. The data access unit 12 sets the instruction code of the input virtual machine instruction as a retrieval key and retrieves an instruction length and an execution routine address for the instruction code. The instruction length thus retrieved is set to the register DISP0, and the execution routine address thus retrieved is set to the register VPC0. The execution routine address set to the register VPC0 is transferred to the register VPC in response to the fact that the prescribed condition is applied subsequently to the end of the execution of the execution routine which is being carried out, and is utilized for generating an access address (execution routine instruction address) of the execution space of the execution routine prescribed by the execution routine address.

The execution routine includes a native instruction for a return processing of returning the program counter PC of the CPU 2 to the head of a predetermined address space (a virtual machine instruction execution space) assigned to the execution of a virtual machine instruction at an end thereof, for example, which is not particularly restricted. When the return to the head of the virtual machine instruction execution space is carried out at the end of the execution routine, the address of an execution routine corresponding to a virtual machine instruction to be executed next has already been prepared in the VPC0. When the CPU 2 is to carry out a processing of giving access to the starting address of the virtual machine instruction execution space again, the address of the register VPC0 is transferred to the register VPC so that the execution of an execution routine indicated by the register VPC0 can be started.

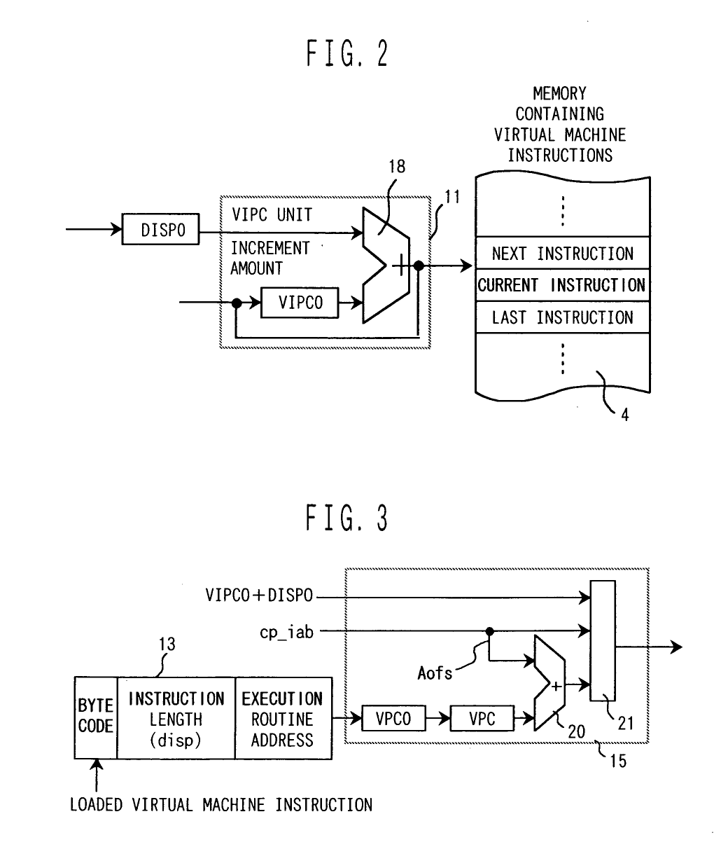

FIG. 2 illustrates the details of the VIPC unit 11. The register VIPC0 indicates the address of a virtual machine instruction which is being executed. The register DISP0 indicates a relative position from the virtual machine instruction which is being executed to a next virtual machine instruction. The relative position from the virtual machine instruction to the next virtual machine instruction represents the instruction length of the virtual machine instruction which is being executed other than a branch instruction. For this reason, the DISP0 acts as the instruction length of the virtual machine instruction other than the branch instruction. As described above, the memory 4 containing virtual machine instructions is accessed by setting VIPC0+DISP0 to be an address for a next instruction in parallel with the execution of the execution routine by the CPU 2. 18 denotes an adder. Subsequently, VIPC0+DISP0→VIPC0 is set to update the VIPC0. Consequently, a next virtual machine instruction can be specified. Since the instruction length of the virtual machine instruction is varied for each instruction, the value of the DISP0 is not determined before the execution of the same instruction. As described above, therefore, the set value of the DISP0 is determined by referring to the table 13 in the same manner as the execution routine address.

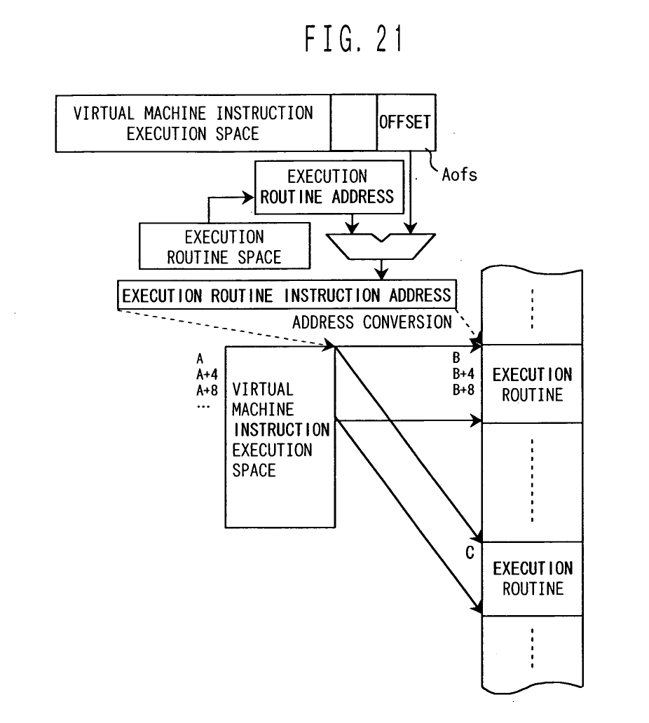

FIG. 3 illustrates the details of the execution address generating unit (VPC unit) 15. The execution address generating unit 15 is constituted by the registers VPC0 and VPC, an adder 20 and a selector 21. The register VPC0 retains the execution routine address of a virtual machine instruction to be processed next. The register VPC retains the execution routine address of a virtual machine instruction which is being processed. The execution routine addresses retained by the registers VPC0 and VPC are the starting addresses of the execution routine, and the execution routine is usually constituted by a plurality of native instructions. Low order plural bits (address offset) Aofsof an instruction fetch address output sequentially by the CPU 2 are added to the value of the register VPC by the adder 20 in such a manner that the CPU 2 can sequentially fetch the native instruction constituting the execution routine. It is sufficient that the number of the bits of the address offset Aofs is the number of address bits corresponding to the maximum value of the memory capacity of each execution routine. For example, 8 bits are employed. According to this example, the sum of the execution routine address stored in the conversion table and the address offset Aofs of the starting address in the virtual machine instruction execution space is the starting instruction address of the execution routine. For example, this acts as the starting address of the virtual machine instruction execution space. FIG. 21 shows a technique for generating an execution routine instruction address from the execution routine address and the address offset Aofs of the CPU which is readjusted.

The selector 21 selects the native instruction address of an execution routine output from the adder 20, the virtual machine instruction address (VIPC0+DISP0) output from the VIPC unit 11 or the address of the address bus cp_iab and outputs one of them to the bus iab. The selecting operation of the selector 21 is controlled by the control unit 10. The control unit 10 inputs a flag for a conditional branch of the CPU 2, a bus ready signal, a bus acknowledge signal and an address signal sent from the CPU 2. The control unit 10 causes the selector 21 to select the address of the address bus cp_iab when the instruction fetch address output from the CPU 2 does not specify the virtual machine instruction execution space, and causes the selector 21 to select the output address of the adder 20 when the instruction fetch address specifies the virtual machine instruction execution space. The control unit 10 causes the selector 21 to select a virtual machine instruction address to be processed next in a predetermined timing in the middle when the selector 21 is caused to select the output address of the adder 20. The predetermined timing is not particularly restricted but may be a uniform timing, that is, the next to the head instruction fetch of the execution routine. As described above, the value of the register VPC0 is acquired in parallel with the processing of the current execution routine of the virtual machine instruction by the CPU 2. When the processing of the current virtual machine instruction is ended, it is possible to instantly carry out a transition to the processing of an execution routine corresponding to a next virtual machine instruction.

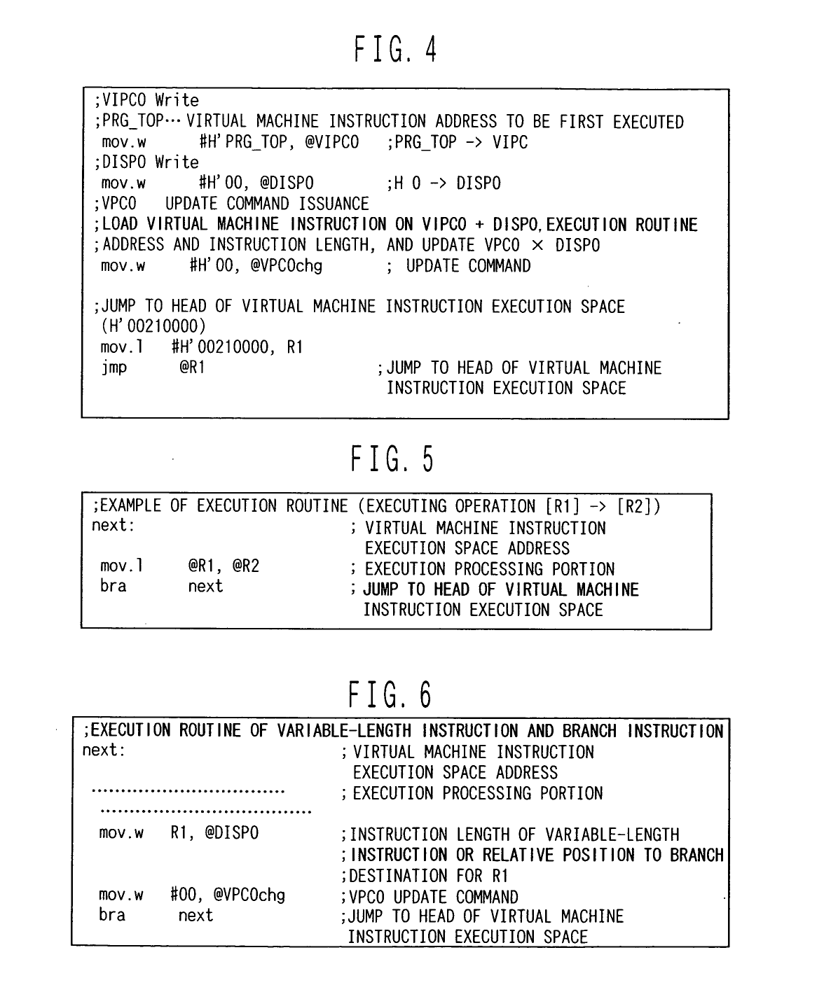

FIG. 4 illustrates the processing program of the CPU 2 for carrying out a transition from an initial state to the state of the execution of a virtual machine instruction. As described above, the state of the execution of the virtual machine instruction can be implemented by a jump to the virtual machine instruction execution space. In the case in which a transition from the initial state is carried out, the CPU 2 first initializes the registers VIPC0, DISP0 and VPC of the address converting unit 3. According to the processing program of FIG. 4, the CPU 2 initializes the register VIPC0 and the register DISP0 and a command for obtaining the set value of the register VPC0 is then executed. The address of a virtual machine instruction to be first executed is set to be the value of the VIPC0 and 0 is set to the DISP0. A command VPC0chg for obtaining the set value of the VPC0 outputs the address of the VIPC0+DISP0, loads a virtual machine instruction positioned on VIPC0+DISP0, acquires an execution routine address corresponding thereto to set the same address to the VPC0, obtains a relative position to a next instruction and sets the same relative position to the DISP0. Subsequently, a jump to the virtual machine instruction execution space is carried out and a transition to the state of the execution of the virtual machine instruction is performed.

FIG. 5 shows an example of an execution routine other than a branch instruction. The address converting unit 3 loads a next virtual machine instruction and acquires an execution routine address corresponding thereto. For this reason, the execution routine includes only a jump to an execution processing portion and the starting address of a virtual machine instruction execution space.

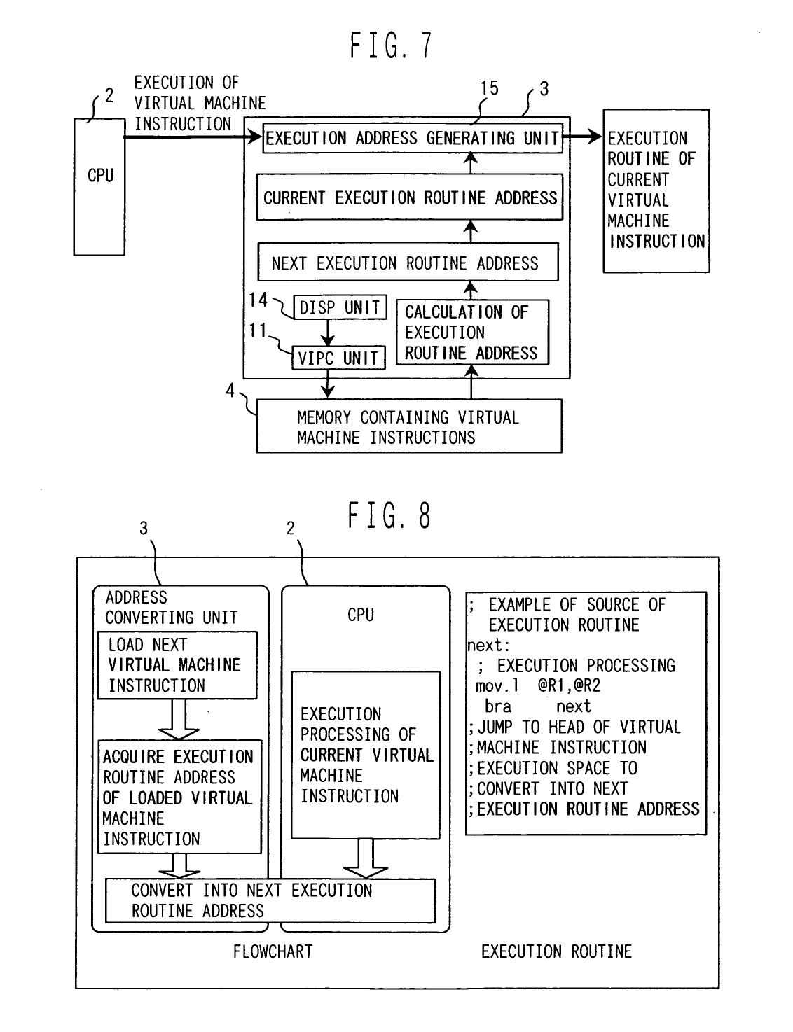

FIG. 6 shows an example of the execution routine of a variable-length instruction and a branch instruction. In case of the variable-length instruction and the branch instruction, an instruction length is unknown before the execution. For this reason, it is impossible to load a virtual machine instruction by the address converting unit 3. The reason is that the address converting unit 3 also obtains a next instruction length by referring to the conversion table 13. For this reason, a position to a next virtual machine instruction is specified within the execution routine and is thus processed in accordance with a command. As illustrated in FIG. 6, the DISP0 is updated to a relative position to a next virtual machine instruction or a branch destination and the update command of the VPC0 is executed. Consequently, it is possible to execute the virtual machine instructions of the variable-length instruction and the branch instruction. In the case in which the update command of the VPC0 is to be executed in the execution routine of the branch instruction and the variable-length instruction of the virtual machine instruction, the value of the instruction length defined in the conversion table of FIG. 1 is added to the position of a current virtual machine instruction by the address converting unit 3. Therefore, the VIPC0 does not indicate the position of the current virtual machine instruction. According to the VPC0 update command, the VIPC0 is to know the address of the current virtual machine instruction. Therefore, the instruction length of the conversion table of the virtual machine instruction is defined as 0 to the conversion table in order not to update the VIPC0 by the address converting unit 3. FIG. 7 wholly shows the address converting function of the address converting unit 3. When an instruction fetch address output from the CPU 2 specifies the virtual machine instruction execution space, the address converting unit 3 converts the address of the address bus cp_iab into the address of the native instruction constituting the execution routine of the virtual machine instruction to be currently processed and outputs the address. In parallel therewith, a read is carried out from the memory 4 containing virtual machine instructions based on a next virtual machine instruction address generated by the DISP unit 14 and the VIPC unit 11, and an address calculation is performed based on the virtual machine instruction thus read to previously acquire an execution routine address to be next executed.

FIG. 8 typically shows the function of executing a virtual machine instruction using the address converting function of the address converting unit 3. In the case in which the address converting unit 3 is used, the execution routine includes only a jump instruction (bra next) to the execution processing portion and the head of the virtual machine instruction execution space. Reference is made to an execution routine address corresponding to the load of a next virtual machine instruction by the address converting unit 3 in parallel with the instruction executing operation of the CPU 2. A transition to a processing based on a next execution routine is implemented by converting the output address of the CPU 2 into a next execution routine address when the jump to the head of the virtual machine instruction execution space is carried out.

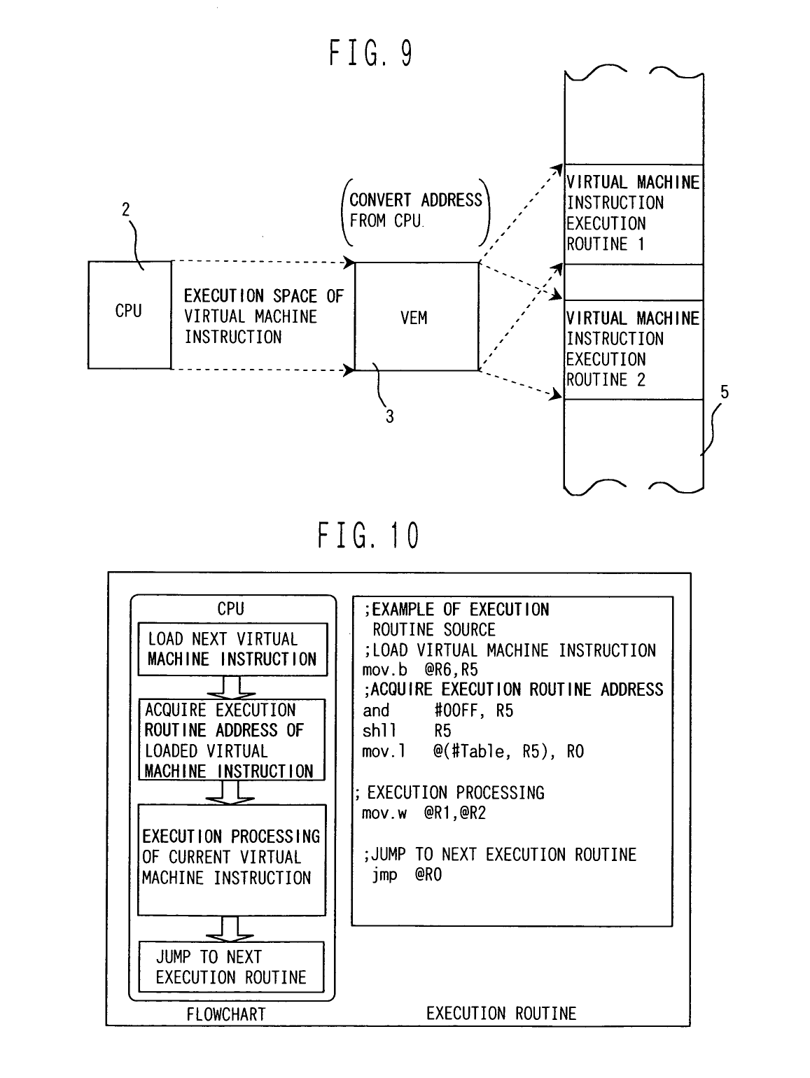

FIG. 9 shows the image of an address conversion using the address converting unit 3. For example, when the CPU 2 indicates a virtual machine instruction execution space (H′0021_{—}0000 to H′0021_{—}0100), the address is converted into an execution routine address corresponding to the loaded virtual machine instruction and is held in the register VPC0. The execution routine address jumps to the head (H′0021_{—}0000) of the virtual machine instruction execution space so that the value of the register VPC0 is transferred to the register VPC and is updated. If the operation for jumping to the head address of the virtual machine instruction execution space is carried out when the processing of executing a current execution routine is ended, accordingly, it is possible to carry out a transition to the execution state of a next execution routine.

FIG. 10 typically shows the function of executing a virtual machine instruction according to a comparative example in which an execution routine is caused to have the function of loading a virtual machine instruction. In case of the comparative example, the virtual machine instruction is loaded in the execution routine. Next, the address of an execution routine corresponding to the loaded virtual machine instruction is obtained by referring to a memory storing an execution routine address. Subsequently, an execution processing portion for a current virtual machine instruction is executed and a jump to a next execution routine address is carried out when the execution is ended. By repeating this operation, it is possible to continuously execute the virtual machine instruction. The load of the virtual machine instruction and the acquirement of an execution routine address corresponding thereto are carried out in series to the processing of the execution processing portion in the execution routine. In case of the comparative example, therefore, the execution efficiency of the virtual machine instruction is lower than that in the parallel processing using the address converting unit 3.

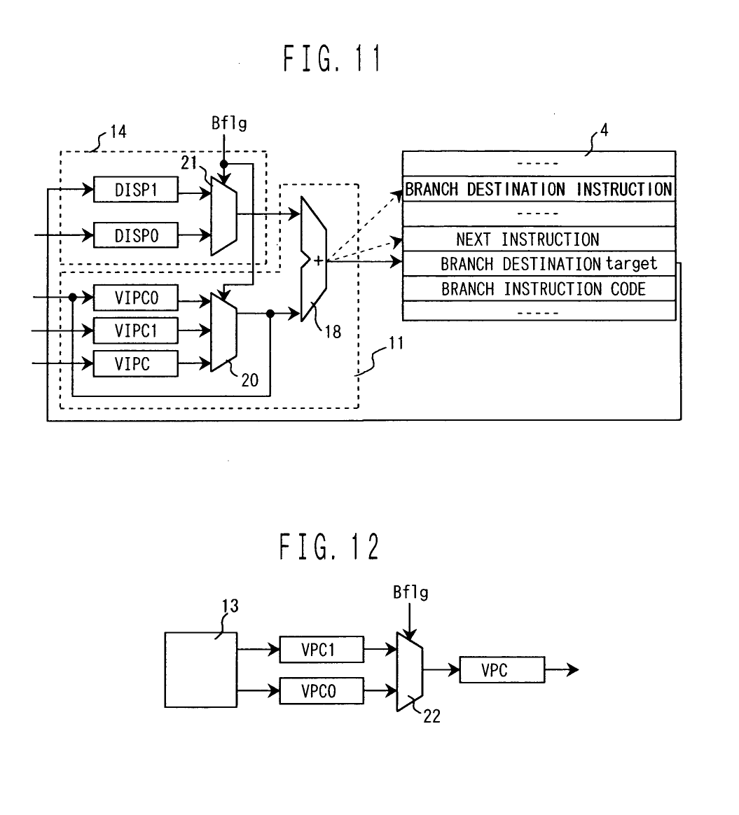

FIG. 11 shows an example of the VIPC unit 11 and the DISP unit 14 for implementing an increase in the speed of a processing to be carried out in accordance with a conditional branch instruction of a virtual machine instruction (a virtual machine conditional branch instruction). FIG. 12 shows an example of the VPC unit 15 for implementing an increase in the speed of the processing to be carried out in accordance with the same virtual machine conditional branch instruction.

The conditional branch instruction of the virtual machine instruction has a relative position (target) of a branch destination written next to a conditional branch instruction code. The VIPC unit 11 has three registers VIPC, VIPC0 and VIPC1 and a selector 20 thereof. The register VIPC is an address register for loading data on an operand portion in a virtual machine instruction which is being executed. The register VIPC does not influence an operation for the program counter PC, and an update to a value indicative of the position of an operand which is obtained by adding 1 to the VIPC0 is carried out when the execution routine of the virtual machine instruction is started to be executed from a head. The conditional branch instruction of the virtual machine instruction employs a technique for a relative branch to obtain a branch destination on the basis of the address position of a current virtual machine instruction. For this reason, information about the address position of the current virtual machine instruction is required. In order to increase the speed of the conditional branch instruction, the branch destination and a virtual machine instruction to be a next instruction are loaded. When the register VIPC0 loads a next virtual machine instruction code, therefore, the address value of the current virtual machine instruction is updated to the address value of the next virtual machine instruction. In this case, it is necessary to know the address value of the current virtual machine instruction when a branch destination address is to be calculated in the load of a branch destination virtual machine instruction. Therefore, the register VIPC1 for storing the address value of the current virtual machine instruction is added.

By outputting an address held in the VIPC, it is possible to obtain the relative position (the branch destination target) for a branch to be operand data in the conditional branch instruction of the virtual machine instruction, and the register DISP1 for storing the value is provided. The registers DISP0 and DISP1 are selected by the selector 21. VIPC1+DISP1 indicates the address position of the virtual machine instruction of a branch destination, and the value is output as an address so that the virtual machine instruction of the branch destination can be loaded. In this case, the VIPC1 is updated by the branch destination address.

Consequently, the retrieval table 13 is accessed by setting, as a retrieval key, the virtual machine instruction of the loaded branch destination, and an instruction length and an execution routine address of the branch destination are obtained and stored in the register DISP1 of FIG. 11 and a register VPC1 of FIG. 12. In case of an unconditional branch such as a jump in place of the conditional branch, it is preferable to update the registers DISP0 and the register VPC0 based on the instruction length and the execution routine address of the branch destination.

As a result of the decision of the branch condition, the registers VIPC0, DISP0 and VPC0 are selected if the branch is not carried out (the disable state of a branch flag Bflg). The registers VIPC1, DISP1 and VPC1 are selected in the case in which the branch is carried out (the enable state of the branch flag Bflg). Consequently, it is possible to perform a transition to the processing of the execution routine of the branch destination virtual machine instruction through the conditional branch. 22 denotes a selector for VPC1 or VPC0. The control unit 10 has the branch flag Bflg for determining the presence of a branch in the conditional branch instruction of the virtual machine instruction.

From the foregoing, it is possible to load the branch destination before fixing the branch condition and to acquire the instruction length of the branch destination and the address of the execution routine in parallel with the processing of executing the current virtual machine instruction of the CPU 2.

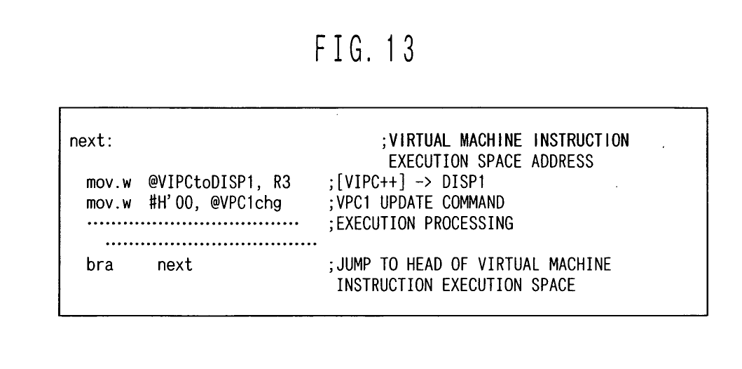

FIG. 13 illustrates an execution routine in the case in which the virtual machine instruction is the conditional branch instruction. First of all, the value of the relative position (Target) is stored in the register DISP1 in accordance with a command indicating the operation of VIPC++→DISP1. Next, the update command of the value of VPC1 is executed and the virtual machine instruction present in the address indicated as the value of VIPC1+DISP1 is loaded, and the instruction length is stored in the DISP1 and the address of the execution routine is stored in the register VPC1. At the same time, the branch condition is set in accordance with the update of the value of the register VPC1. When a jump to the starting address of the virtual machine instruction execution space is carried out after the execution processing, the address converting unit 3 decides the branch by the condition flag (the value of a predetermined bit of a condition code register) of the CPU 2, and a transition to a next processing is carried out. By simply setting a flag for determining the branch condition to the CPU 2 side, it is possible to carry out an actual branch processing in parallel with the processing of the CPU 2 by the address converting unit 3. Consequently, the speed of the processing can be increased.

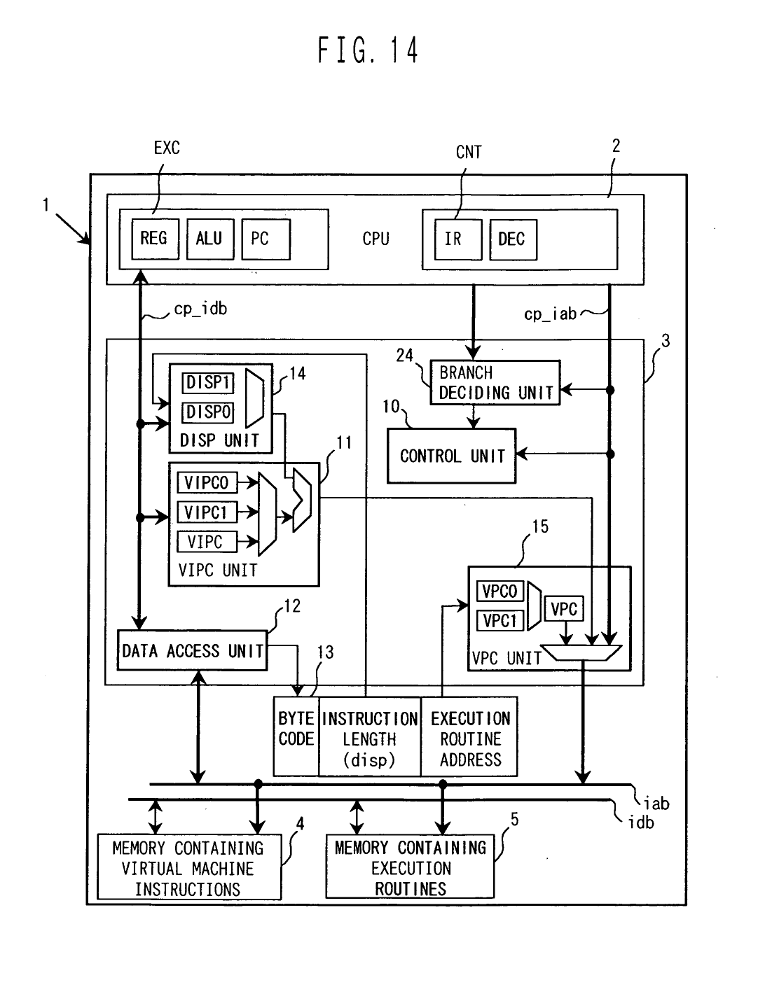

FIG. 14 wholly shows a microcomputer employing the method of increasing the speed of the branch processing of a virtual machine conditional branch instruction. A branch deciding unit 24 is provided in the former stage of the control unit 10, and it is decided whether or not the branch condition is applied by referring to a condition code register value supplied from the CPU 2. The branch flag Bflg is changed in a predetermined timing by the control unit 10 in accordance with the result of the decision obtained by the branch deciding unit 24.

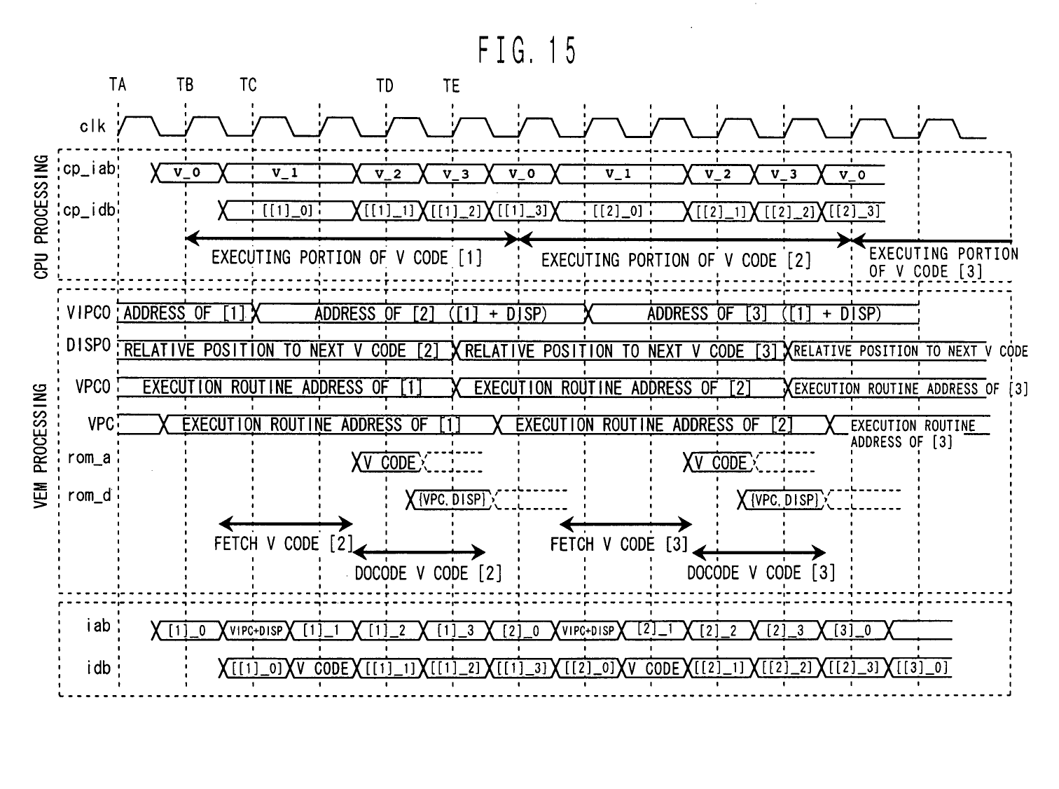

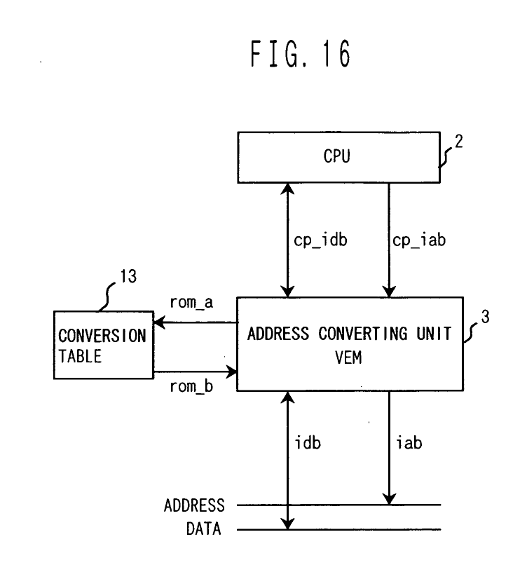

FIG. 15 illustrates the state of the continuous executing operation of a virtual machine instruction by the microcomputer 1 in FIG. 1 or FIG. 14. In a timing of FIG. 15, the CPU 2 processes the execution routines of virtual machine instructions (which will be also referred to as V codes) [1], [2] and [3] based on a connecting relationship shown in FIG. 16. V_0 to V_3 indicate the address of a virtual machine instruction execution space and V_0 indicates a starting address thereof.

As illustrated in a timing TA, in an initial state, the memory address of the V code [1], a relative position to the next V code [2] and the execution routine address of the V code [1] are initialized to the registers VIPC0, DISP0 and VPC0 by the CPU 2, respectively.

When the starting address V_0 of the virtual machine instruction execution space is output from the CPU 2 to the address bus cp_iab (timing TB), the address converting unit 3 detects the same address and transfers the value of the register VPC0 to the register VPC and outputs, to the address bus iab, a native instruction address [1 ]_0 constituting the execution routine of the V code [1] of the register VPC which is obtained by adding the low order offset of the address V_0 to the execution routine address of the V code [1]. A native instruction [[1]_0] is output from the memory 5 containing execution routines to the data bus idb based on an address thereof (timing TC). This is fetched to the CPU 2 through the bus cp_idb and is executed. Every time the addresses V_1 to V_3 of the virtual machine instruction execution space are sequentially output from the CPU 2 to the address bus cp_iab, succeeding native instructions [[1]_1] to [[1]_3] of the execution routines corresponding to the V codes are sequentially supplied to the CPU 2.

In the example of FIG. 15, the address converting unit 3 reads the head instruction of the execution routine, and then adds the relative value of the register DISP0 to the memory address of the Vcode [1] and outputs the address (VIPC0+DISP0) of the V code [2] to the bus iab as shown in the timing TC, and reads the next Vcode [2] from the memory 4 containing virtual machine instructions (timing TD). During that interval, the native instruction [[1]_1] is waited to be read based on the address [1]_1, and subsequently, the native instruction is sequentially read. In parallel with the execution of the native instruction read by the CPU 2, the address converting unit 3 gives access to the conversion table 13 by setting the read V code [2] as an address, thereby setting a relative position to the V code [3] of the register DISP0 depending on the read instruction length and setting the execution routine address of the V code [2] to the VPC0 based on the execution routine address (timing TE).

In FIG. 15, the end of the execution routine of the V code [1] is set to be a jump instruction [[1]_3]. When the program counter PC of the CPU 2 is branched into the starting address V_0 of the virtual machine instruction execution space in accordance with the final jump instruction, the address of the execution routine of the V code [2] which has already been acquired by the register VPC0 is transferred to the register VPC and the CPU 2 can be caused to sequentially execute an execution routine setting [2]_0 to be a head at this time.

When the CPU 2 is processing the execution routine of the V code, accordingly, the address converting unit 3 fetches a next V code from the memory 4 in parallel with the processing and acquires the starting address and instruction length of the execution routine from the conversion table 13 by setting the fetched V code to be an address. Accordingly, a jump instruction to return to the head to the virtual machine instruction execution space is executed at the end of the execution routine so that the CPU 2 can execute a necessary execution routine sequentially and continuously.

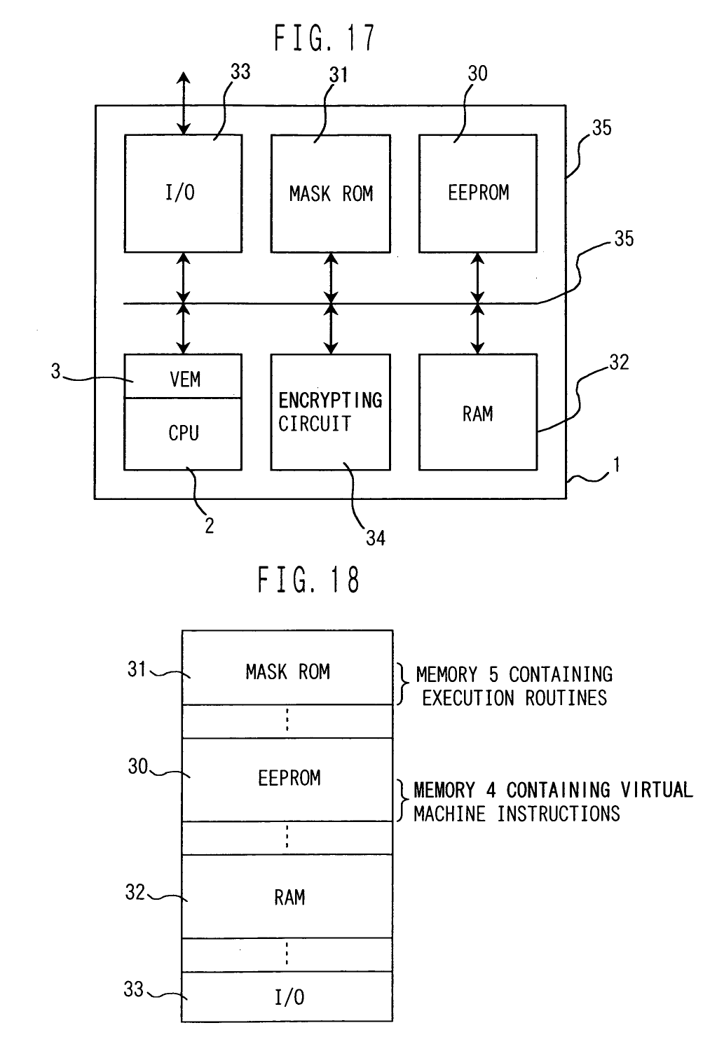

FIG. 17 schematically shows the whole microcomputer 1. The microcomputer 1 shown in FIG. 17 is not particularly restricted but is a microcomputer which is referred to as a so-called IC card microcomputer. The microcomputer 1 shown in FIG. 17 is formed by a technique for manufacturing a semiconductor integrated circuit such as a CMOS on a semiconductor substrate or semiconductor chip such as monocrystalline silicon.

The microcomputer 1 has the CPU 2, the address converting unit 3 (VEM 3), an EEPROM 30 which is electrically rewritable, a mask ROM 31, an RAM (Random Access Memory) 32, an input/output circuit (I/O) 33, an encrypting circuit 34 and an internal bus 35. The input/output circuit 33 is utilized for the interface of an I/O signal such as an address, data or a command, a reset signal and a clock signal.

As illustrated in an address map in FIG. 18, the EEPROM 30 is used for the memory 4 containing virtual machine instructions. The mask ROM 31 is used for the memory 5 containing execution routines. A virtual machine program to be an application program is input from the input/output circuit 33. Since the virtual machine program is encrypted in a normal input, it is decoded by the encrypting circuit and the result of the decoding is stored in the EEPROM 30. The execution routine is stored in the mask ROM 31 and the CPU 2 executes an execution routine corresponding to a virtual machine instruction so that the execution of a virtual machine program is implemented.

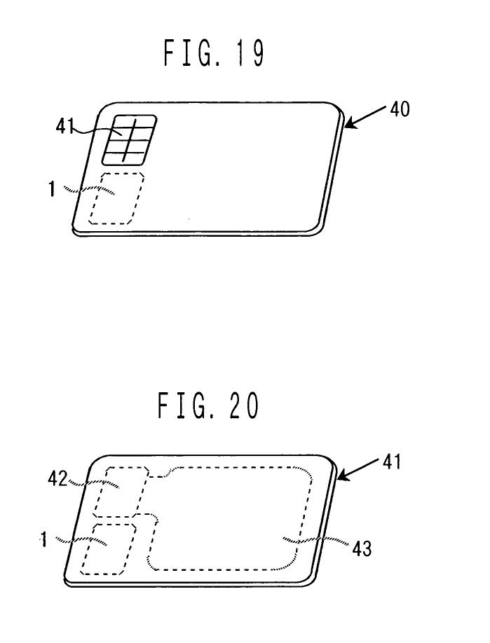

FIG. 19 illustrates a contact interface type IC card which applies the microcomputer 1. In an IC card 40, the microcomputer 1 is mounted on a card board and is sealed with a resin or casing. An external terminal 41 is exposed from a surface. The external terminal 41 is connected to the input/output circuit 33 of the microcomputer 1 with a wiring provided on the card board.

FIG. 20 illustrates a non-contact interface type IC card which applies the microcomputer 1. In the IC card 41, the microcomputer 1, and a high frequency unit (RF unit) 42 and an antenna 43 are mounted on a card board and are sealed with a resin or casing. The antenna 43 is connected to the high frequency unit 42 and the input/output circuit 33 of the microcomputer 1 is connected to the high frequency unit 42 with a wiring provided on the card board. The high frequency unit 42 can also be constituted in on-chip with the microcomputer 1. The high frequency unit 42 outputs a supply voltage Vcc by setting, as an operating power supply, an induced current generated by crossing a predetermined radio wave (for example, a microwave) by the antenna 43, and generates a reset signal and a clock signal and inputs/outputs information from/to the antenna 43 in non-contact. The input/output circuit 33 exchanges, with the RF unit 42, information to be input/output to/from an outside.

While the invention made by the inventor has been specifically described above based on the example, the invention is not restricted thereto but various changes can be made without departing from the scope of the invention.

A specified condition that an address conversion is carried out by the address converting unit is not restricted to the output of the starting address of the virtual machine instruction execution space. For example, the starting address is not always required. Moreover, a specific address is not always required but other specific output states of the CPU may be brought. In addition, the memory containing virtual machine instructions and the memory containing execution routines are not restricted to non-volatile memories but they may be constituted by volatile memories if the stored data can be held. Furthermore, the memory containing virtual machine instructions may be connected to a separate bus from the memory containing execution routines, for example, a dedicated bus in the same manner as in the conversion table. It is possible to prevent the access of the execution routine from being temporarily broken by the access of a virtual machine instruction. Moreover, the address converting unit can also be constituted in the same unit as an instruction control unit and an executing unit which form a CPU in the same manner as a memory management unit. Furthermore, the microcomputer can also be applied to a PDA (Personal Digital Assistant) and a cell phone as well as an IC card.

The invention can be widely applied to a data processing apparatus which is referred to as a microcomputer, a data processor, a microprocessor or a single chip data processor to be the platform of a virtual machine program constituted by a virtual machine instruction, and furthermore, an electronic apparatus such as an IC card mounting the data processing apparatus.

What is claimed is:

1. A data processing apparatus capable of implementing an execution of a virtual machine instruction based on an execution routine specified by a native instruction of a CPU, comprising:
an address converting unit capable of sequentially converting an address output from the CPU into an address of the native instruction by utilizing an address of a prepared execution routine in response to an application of a prescribed condition,
the address converting unit reading a virtual machine instruction to be executed next and preparing an address of an execution routine corresponding thereto in parallel with an execution of the execution routine by the CPU based on the address of the native instruction which is sequentially converted.

2. The data processing apparatus according to claim 1, wherein the address converting unit exactly outputs an address input from the CPU in response to a non-application of the prescribed condition.

3. The data processing apparatus according to claim 1, wherein the prescribed condition is an output of a predetermined address by the CPU.

4. The data processing apparatus according to claim 3, wherein the predetermined address is a starting address of a predetermined address space assigned to the execution of the virtual machine instruction.

5. The data processing apparatus according to claim 4, wherein the execution routine includes a native instruction of a return processing of returning a program counter of the CPU to a head of the predetermined address space assigned to the execution of the virtual machine instruction at an end thereof.

6. The data processing apparatus according to claim 1, further comprising a conversion table for defining a correspondence of an instruction length to an address of an execution routine for each virtual machine instruction.

7. The data processing apparatus according to claim 6, further comprising a first register for holding an instruction length acquired from the conversion table corresponding to a virtual machine instruction and a second register for holding an address of an execution routine which is acquired.

8. The data processing apparatus according to claim 7, wherein the address converting unit h as a virtual machine program counter for outputting an address to read a virtual machine instruction from a memory and an amount of an increment of the virtual machine program counter can be controlled based on a value of the first register.

9. The data processing apparatus according to claim 8, wherein the increment of the virtual machine program counter is carried out synchronously with an execution end timing of an execution routine.

10. The data processing apparatus according to claim 7, wherein the address converting unit has an execution routine address generating circuit for reading a native instruction of an execution routine from a memory, and
the execution routine address generating circuit has a third register for inputting an address of an execution routine held by the second register and an adder for adding a value of the third register to a plurality of bits on a low order side of an address output from the CPU, and an output of the adder is set to be an address of a native instruction of an execution routine.

11. The data processing apparatus according to claim 1, wherein when a virtual machine instruction which is read is a branch instruction, the address converting unit can read a virtual machine instruction of a branch destination and can prepare an address of an execution routine corresponding thereto.

12. The data processing apparatus according to claim 1, wherein when a virtual machine instruction which is read is a conditional branch instruction, the address converting unit further reads a virtual machine instruction of a branch destination and separately prepares an address of an execution routine corresponding thereto, and selects an address of an execution routine to be utilized for an address conversion depending on a presence of a branch.

13. The data processing apparatus according to claim 1, further comprising a first memory for storing a virtual machine program constituted by a virtual machine instruction and a second memory for storing an execution routine thereof for each virtual machine instruction, the data processing apparatus being formed on a semiconductor chip.

14. The data processing apparatus according to claim 13, wherein the second memory further has an instruction length of a virtual machine instruction.

15. The data processing apparatus according to claim 13, wherein the first memory is a rewritable non-volatile memory.

16. An IC card having an input/output circuit and a data processing apparatus connected to the input/output circuit on a card board,
wherein the data processing apparatus can implement an execution of a virtual machine instruction by an execution routine specified by a native instruction of a CPU and has an address converting unit for sequentially converting a predetermined address output from the CPU into an address of the native instruction by utilizing an address of an execution routine which is prepared,
the address converting unit reading a virtual machine instruction to be executed next and preparing an address of an execution routine corresponding thereto in parallel with an execution of an execution routine by the CPU based on the address of the native instruction which is sequentially converted.
